(19) United States
(12) Patent Application Publication
(10) Pub. No.: US 2015/0281019 A1
(43) Pub. Date: Oct. 1, 2015

(54) INFORMATION COMMUNICATION SYSTEM, INFORMATION PROCESSING APPARATUS AND INFORMATION PROVISION METHOD

(71) Applicant: SEIKO EPSON CORPORATION, Tokyo (JP)

(72) Inventor: Tsutomu HASHIZUME, Minamiminowa-mura (JP)

(21) Appl. No.: 14/667,887

(22) Filed: Mar. 25, 2015

(30) Foreign Application Priority Data
Mar. 27, 2014 (JP) 2014-065428

(51) Int. Cl. H04L 12/26; H04L 29/08

(52) U.S. Cl. CPC H04L 43/0805; H04L 67/10

(57) ABSTRACT

An information communication system includes an information processing apparatus and a monitoring apparatus that communicates with the information processing apparatus to monitor the information processing apparatus. The information processing apparatus includes an information acquirement unit that acquires multiple types of operational information which vary according to operation of the information processing apparatus, a receiving unit that receives a setting input for selecting operational information that is transmitted to the monitoring apparatus, from among the multiple types of operational information, and a communication unit that transmits the operational information selected by the setting input to the receiving unit to the monitoring apparatus. The monitoring apparatus includes a storage unit in which the operational information transmitted from the information processing apparatus is stored, and a monitoring unit that monitors an operational situation of the information processing apparatus based on the operational information stored in the storage unit.

### BACKGROUND

1. Technical Field

The present invention relates to maintenance of an information processing apparatus that has a communication function.

2. Related Art

In principle, it is possible to remotely monitor an operational situation of an information processing apparatus that has a communication function over a communication line such as a local area network (LAN). As the information processing apparatus, for example, there is an image formation apparatus such as a network printer. That is, in the image formation apparatus, an amount of remaining consumables such as ink or a recording medium varies according to operation of the image formation apparatus, and deterioration in constituent components of the apparatus proceeds. It is possible to detect information relating to such operational history within the apparatus. If the information is transmitted to an external monitoring apparatus over a communication line, an operational situation of the image formation apparatus can be remotely monitored by a monitoring apparatus. Furthermore, for example, it is also possible to predict a trend for a malfunction of the apparatus to occur and thus prevent a malfunction before the malfunction occurs, by analyzing such operational information collected individually from many apparatuses. Thus, a result of the analysis can be used for feedback to product development.

However, due to concern for security and the like, the user may not necessarily proactive in transmitting information relating to a mode of the use of the information processing apparatus to the outside, and may be reluctant to connect the apparatus to a communication line. With regard to this problem, with the technology disclosed in JP-A-2012-039183, a terminal apparatus that a full-time customer engineer carries is connected to an image formation apparatus and the customer engineer can understand an operational situation of the image formation apparatus. Furthermore, information stored in the terminal apparatus is transmitted to a separate maintenance management server and is managed in an integrated manner.

The technology in the related art is for supporting maintenance work that is performed by a customer engineer who makes a field-visit the field when a malfunction of an apparatus disconnected from a communication line occurs, but is not for monitoring the apparatus at the server side to which information relating to the operational situation is transmitted from the apparatus at any time. Therefore, in principle, it is impossible to prevent a malfunction of the apparatus before the malfunction occurs. Furthermore, there is no difference in that, regardless of a user's intention, the information relating to the operational situation of the apparatus is transmitted to the terminal apparatus of the customer engineer or to a maintenance management server. Because of this, it cannot be said that sufficient consideration is given to the user's concern for information management.

### SUMMARY

An advantage of some aspects of the invention is to provide a technology that acquires information from an information processing apparatus in a manner satisfactory to an individual user and is used for remote monitoring of the apparatus or development of a new product.

According to an aspect of the invention, there is provided an information communication system including: an information processing apparatus; and a monitoring apparatus that communicates with the information processing apparatus to monitor the information processing apparatus, in which the information processing apparatus includes an information acquirement unit that acquires multiple types of operational information which vary according to operation of the information processing apparatus, a receiving unit that receives a setting input for selecting operational information that is transmitted to the monitoring apparatus, from among the multiple types of operational information, and a communication unit that transmits the operational information selected by the setting input to the receiving unit to the monitoring apparatus, and in which the monitoring apparatus includes a storage unit in which the operational information transmitted from the information processing apparatus is stored, and a monitoring unit that monitors an operational situation of the information processing apparatus based on the operational information stored in the storage unit.

In this case, a user of the information processing apparatus himself/herself can select a type of operational information that is transmitted from the information processing apparatus to the monitoring apparatus. Therefore, the user's concern that a user will not understand what type of information is transmitted and how that information is used, or the user's reluctance to transmit information can be removed.

In the system described above, for example, the multiple types of operational information may be ranked based on a given criteria, and among the multiple types of operational information, the communication unit may transmit pieces of operational information from operational information with the highest ranking down to operational information with a ranking corresponding to a result of the setting input.

There are various types of operational information from operational information necessary for minimum management of the apparatus to operational information necessary only for high-precision management. For this reason, although the user can arbitrarily select operational information from among the various type of operational information, a combination of these pieces of operational information is not necessarily effective. Thus, more efficient management is possible if pieces of operational information are ranked based on a certain criteria and the user makes a selection according to such a ranking order.

Furthermore, for example, the monitoring apparatus may include a monitoring-side communication unit that transmits information to the information processing apparatus, and among multiple types of service information relating to maintenance of the information processing apparatus, the monitoring unit may transmit service information in accordance with a type of the operational information that is transmitted from the information processing apparatus, to the monitoring-side communication unit. With this configuration, useful information relating to management of the information processing apparatus can be provided to the user by transmitting the service information from the monitoring apparatus to the information processing apparatus. In this case, suitable service information adequate for a status of the information processing apparatus can be provided by setting contents of the service information to be contents in accordance with the type of operational information that is transmitted from the information processing apparatus.

The service information may be information that is automatically processed by the information processing apparatus that receives the service information, and may be a message and the like to the user. Then, for example, in the system, the information processing apparatus may be configured to include a reporting unit that reports the service information that is transmitted from the monitoring apparatus. When this is done, for example, the situation of the apparatus is notified to the user and thus a malfunction can be avoided before the malfunction occurs, or a monitoring function such as guiding the user through a method of fixing a minor malfunction can be realized.

In this case, the reporting unit may report a type of the operational information that is transmitted by the communication unit and a type of service information that is received from the outside according to the operational information with the type of the operational information and the service information being associated with each other. A selection operation by the user can be efficiently supported by making clear a relationship between the operational information that is transmitted from the information processing apparatus and the service received by the information processing apparatus. Furthermore, the user can be encouraged to provide more pieces of information by presenting contents of the service.

Furthermore, in the system, for example, the monitoring unit may create maintenance information necessary for maintenance work for the information processing apparatus based on the operational information stored in the storage unit. With this configuration, maintenance work can be done in accordance with the operational situation of the information processing apparatus.

Furthermore, in the system, multiple information processing apparatuses may be configured in such a manner as to communicate with one monitoring apparatus over a communication line. With this configuration, the operational information that is transmitted from the multiple information processing apparatuses can be managed in the monitoring apparatus in an integrated manner. When this is done, for example, it is possible to statistically process the operational information and thus analyze a cause of the malfunction.

According to another aspect of the invention, there is provided an information processing apparatus including: an information processing unit; an information acquirement unit that acquires multiple types of operational information that vary according to operation of the information processing unit; a communication unit that communicates with an external apparatus; and a receiving unit that receives from a user a setting input for selecting operational information for the communication unit to transmit from among the multiple types of operational information, in which the communication unit transmits the operational information selected by the setting input to the receiving unit to the external apparatus.

The information processing apparatus according to the aspect of the invention can be suitably built into the information communication system described above. With the configuration described, the remote monitoring is correspondingly provided from the outside, and the user of the apparatus can determine, on his/her own initiative, a balance between the information that is provided to the outside and the service that is received.

The information processing apparatus, for example, may be configured to include a reporting unit that reports a type of the operational information that is transmitted by the communication unit and service information that is received from the outside according to the operational information with the type of the operaional information and the service information being associated with each other. With this configuration, as in the information communication system, because a relationship between the operational information that is transmitted from the information processing apparatus and the received service is made clear, the selection operation by the user can be efficiently supported.

Furthermore, for example, the information processing unit may have an image formation unit that forms an image that is based on image data, on a recording medium. By applying the invention to an apparatus that has the image formation unit, a malfunction is prevented before the malfunction occurs, and even if a malfunction occurs, it is possible to receive information for taking a prompt countermeasure from the outside.

In this case, for example, the operational information may include information relating to consumables that are consumed according to operation of the image formation unit. It is possible for the user to receive information on consumption of consumables or suitable information such as the replacement time by transmitting information relating to the consumables from the apparatus.

Furthermore, according to a further aspect of the invention, there is provided an information provision method of providing service information relating to maintenance of an information processing apparatus that has a communication function, from an information provision entity to a user, the method including: causing the user to select operational information to be transmitted to the information provision entity, from among multiple types of operational information that vary according to operation of the information processing apparatus; transmitting the operational information selected by the user from the information processing apparatus to the information provision entity; and providing service information in accordance with the transmitted operational information among multiple types of service information from the information provision entity to the user.

In this case, as described above, the user himself/herself can select information that is transmitted according to a service that is desired to be received, by providing the service information in accordance with the type of operational information that is transmitted. When this is done, the user's reluctance to transmit the information is reduced, and it is possible for an information provision entity to be provided with more pieces of information from more users.

In this case, for example, the multiple types of operational information may be ranked based on a given criteria, and a combination of the pieces of operational information selectable by the user may be limited based on a ranking order. As described above, it is more desirable to make selectable only a combination that is allowed based on the ranking order which is determined in advance according to a given criteria than to freely select the operational information that is transmitted, in that the information useful for the management of the apparatus can be reliably transmitted.

Furthermore, for example, a configuration may be provided in such a manner that the more pieces of operational information the information processing apparatus transmits, the greater the number of types of service information that is provided. When this is done, more pieces of information can be received from the user who desires to receive more pieces of service information.

### BRIEF DESCRIPTION OF THE DRAWINGS

The invention will be described with reference to the accompanying drawings, wherein like numbers reference like elements.

FIG. 1 is a diagram of an information communication system according to one embodiment of the invention.

FIG. 2 is a block diagram illustrating configurations of a computer or a printer.

FIG. 3 is a block diagram illustrating a configuration of a server.

FIG. 4 is a diagram illustrating an example of ranking of pieces of operational information.

FIG. 5 is a diagram illustrating a communication protocol in the information communication system.

### DESCRIPTION OF EXEMPLARY EMBODIMENTS

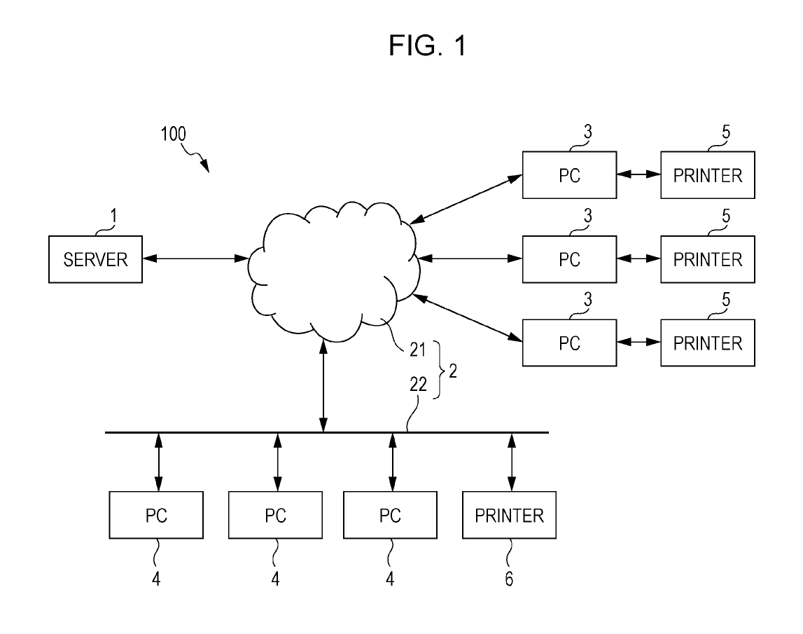

FIG. 1 is a diagram of an information communication system according to one embodiment of the invention. An information communication system 100 includes a server apparatus 1, personal computers (PC) 3 and 4, and printers 5 and 6 that are connected to one another over a communication line. More specifically, in the information communication system 100, the server apparatus 1 and the multiple personal computers (hereinafter simply referred to as a “computer” and is described as a “PC” in the drawings) 3 are connected to an Internet communication network 21. Furthermore, for example, a local area network (LAN) 22 installed within a company is connected to the Internet communication network 21, and the multiple computers 4 are connected to the LAN 22.

A printer 5 is connected to each computer 3, and each computer 3 controls the printer 5 connected to itself. Furthermore, the printer 6 is connected to the LAN 22, and the printer 6 can be controlled from a computer 4 connected to the LAN 22.

Moreover, the information communication system 100 is established by connecting a server and at least one computer or a printer over a communication line. Therefore, the number of computers or printers is arbitrary without being limited to the number of computers or printers illustrated. Furthermore, there are also a mode of connection to the server apparatus 1 over the Internet communication network 21 as is the case with the computer 3, and a mode of connection to the server apparatus 1 over the LAN 22 and the Internet communication network 21 as is the case with the computer 4. Any mode of connection is possible. In addition, a connection mode in which the server apparatus 1 and the computer 4 are connected together over the LAN 22 without the Internet communication network 21 being involved is possible. The Internet communication network 21 and the LAN 22 are hereinafter collectively referred to as a communication line 2 unless particularly necessary to make a distinction. The communication line 2 may be of a wireless type or be of a cable type as long as bidirectional communication is possible.

Furthermore, with respect to the printer, a mode of indirect connection to the communication line 2 through the computer 3 is possible as is the case with the printer 5 and a mode of direct connection to the communication line 2 without a computer being involved is possible as is the case with the printer 6. However, the printer 6 that is connected directly to the communication line 2 needs to have a network connection function.

In the information communication system 100 with this configuration, it is possible for the server apparatus 1 to remotely monitor each of the printers 5 and 6 over the communication line 2. A configuration of each constituent element necessary to make remote monitoring possible will be described below.

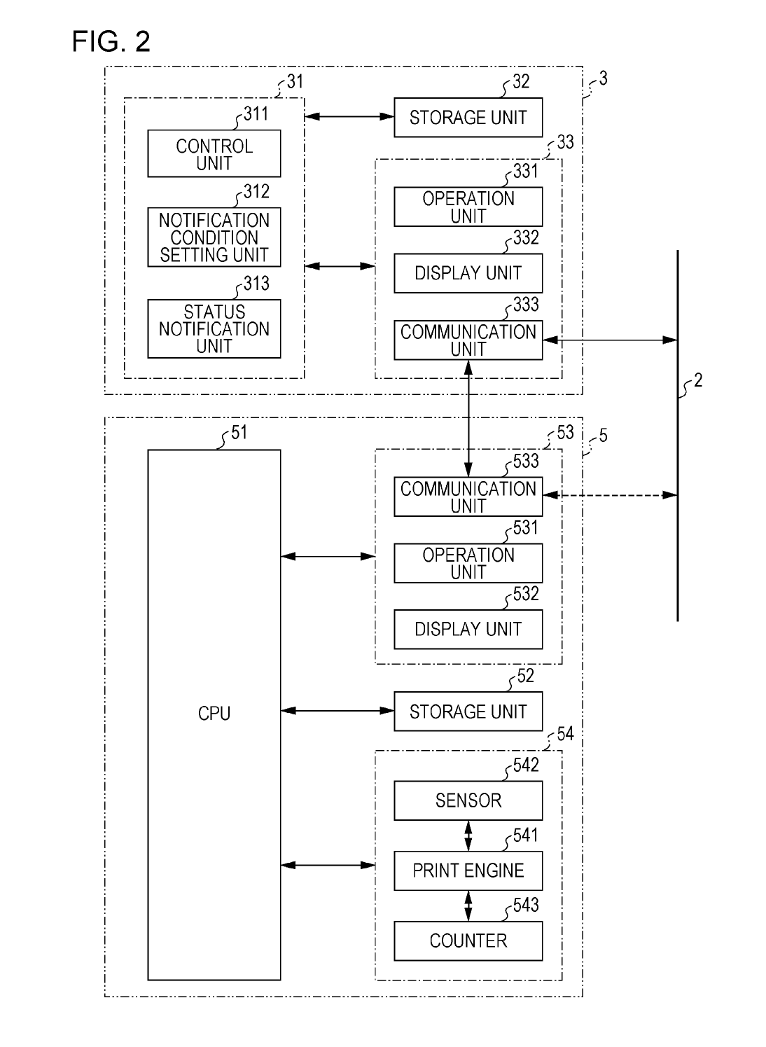

FIG. 2 is a block diagram illustrating configurations of a computer and a printer. The computer 3 includes a central processing unit (CPU) 31 that performs various types of computing processing, a storage unit 32 in which various pieces of information are stored, and an interface unit 33 that performs information exchange with the outside. As the computer 3, a personal computer that has a general configuration can be used. Such a computer can realize various functions by appropriate software being installed, but here, a configuration for realizing a function associated with the remote monitoring of the printer described above is described. Moreover, a configuration of the computer 3 that is a typical example of a computer is described here, and therefore a configuration of the computer 4 is the same as that of the computer 3.

The CPU 31 of the computer 3 has various functional blocks, such as a control unit 311 that executes software stored in the storage unit 32 and thus controls each unit of the computer 3 and performs predetermined processing, a notification condition setting unit 312 and a status notification unit 313 that realize by executing the software, and the like. Functions of the notification condition setting unit 312 and the status notification unit 313 will be described below. The storage unit 32, for example, is made from a memory and a high capacity storage medium, and a control program that has to be run by the CPU 31 or various pieces of data that are generated by processing are stored in the storage unit 32. Furthermore, the storage unit 32 also has a function of accumulating and saving operational information that is generated according to operation of the printer 5 as described below.

For a configuration that is responsible for a user interface, the interface unit 33 includes an operation unit 331 that receives an operation input from a user, and a display unit 332 on which various pieces of information are displayed to provide notification to the user. The operation unit 331, for example, has an input device such as a keyboard or a mouse. The display unit 332, for example, has a display device such as a liquid crystal display. Furthermore, for example, a touch panel may be provided that has both a function of the operation unit 331 and a function of the display unit 332.

Furthermore, the interface unit 33 has a communication unit 333 for communicating with other apparatuses to perform exchange of data. The communication unit 333 has a network connection function for connection to the communication line 2 and a function of performing communication with the printer 5 connected to the computer 3. Specifically, a print command from the CPU 31 and image data containing image contents that have to be printed are given to the printer 5 and a predetermined operation is performed.

The printer 5 is an image formation apparatus that, for example, forms an image on recording media such as a sheet of paper, a piece of cloth, a resin sheet, and a metal sheet, using a recording material such as ink, and toner. There are various types of recording. An arbitrary type of recording is applicable, and for example, an ink jet type is available. The printer 5 includes a CPU 51 that controls each unit by running software that is stored in advance, a storage unit 52 in which image data that has to be printed is temporarily stored, an interface unit 53 that performs information exchange with the outside, and a print unit 54 that performs a print operation according to a control command from the CPU 51.

For a configuration that is responsible for the user interface, the interface unit 53 includes an operation unit 531 that has buttons that receive an operation unit from the user, and a display unit 532 on which various pieces of information are displayed in order to be reported to the user. For example, these may be integrally configured into a touch panel. A communication unit 533 is connected to the communication unit 333 of the computer 3, and thus receives the print command or the image data that is transmitted from the computer 3 and transmits information indicating a status of the printer 5 to the computer 3.

The print unit 54 includes a print engine 541 that is a main component that is responsible for the print operation. The print engine 541 forms an image corresponding to image data on the recording medium according to the control command from the CPU 51. Furthermore, a sensor 542 for detecting various physical quantities relating to an operational status of the print engine 541, and a counter 543 for measuring various numerical values that vary according to operation of the print engine 541 are provided in the print unit 541.

In a case where the print engine 541 is of an ink jet type, as a physical quantity indicating the operational status of the print engine 541, for example, there are a voltage that is applied to electrical components of the print engine 541, a temperature and humidity within the apparatus, a position of a printing head or of a recording medium, and the like. As the sensor 542 for detecting these, there are provided various sensors, such as a voltage sensor, a temperature and humidity sensor, a positional sensor, and an acceleration sensor. Furthermore, as the numerical value that varies according to the operation of the print engine 541, for example, there are total operation time of the apparatus, the number of printed sheets, an amount of consumed ink (an amount of remaining ink), and the cumulative number of rotations of a mechanism component that rotates. Various counters 543 for recording these are provided.

Pieces of data that are output from the sensor 542 and the counter 543 are stored, as operational information indicating an operational situation of the printer 5, in the storage unit 52, and are used by the CPU 51 in the operational control of the print engine 541. Furthermore, the operational information is transmitted also to the communication unit 533 through the computer 3. The computer 3 stores the pieces of data in the storage unit 32 and monitors the status of the printer 5. In addition, it is possible for the server apparatus 1 to remotely monitor the printer 5 by transmitting the operational information from the computer 3 to the server apparatus 1.

The printer 6 that is connected directly to the communication line 2 basically has the same configuration as the printer 5 described above. However, the printer 6 needs to be a network printer that has the communication unit 533 which has the network connection function for establishing a connection to the communication line 2 and performing communication as indicated by a dashed-line arrow in the drawings. Furthermore, as described in detail below, in order for the server apparatus 1 to remotely monitor the printer 6 without the computer being involved, functions that are equivalent to the notification condition setting unit 312 and the status notification unit 313 that the CPU 31 of the computer 3 has need to be realized by a CPU of the printer 6.

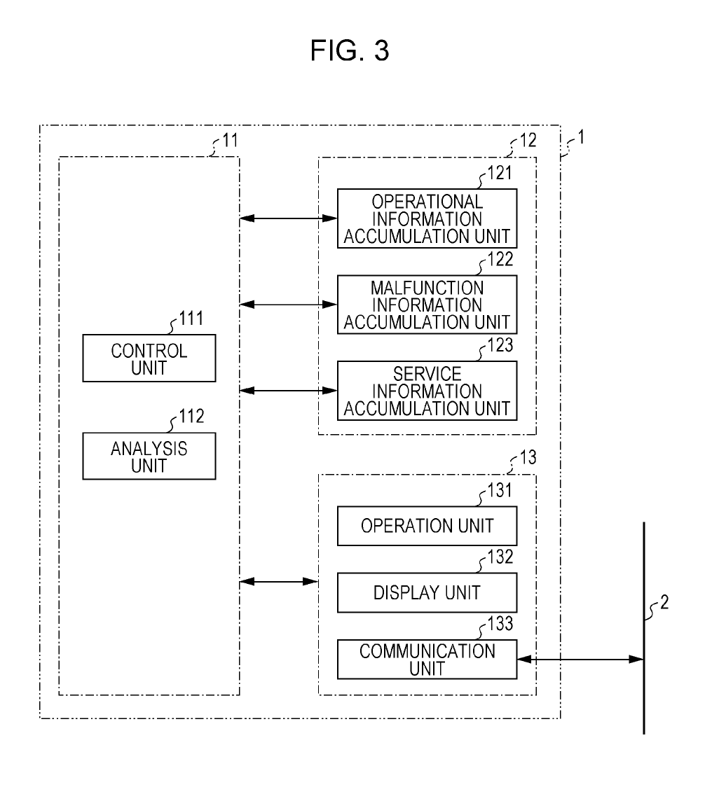

FIG. 3 is a block diagram illustrating a configuration of the server apparatus 1. The server apparatus 1 is installed by a service provider that provides a maintenance service for the printers to the user who installs and manages the printers 5 and 6, in order to remotely monitor the printers 5 and 6. The server apparatus 1 includes a CPU 11 that controls each unit of the apparatus and performs given processing, a data accumulation unit 12 that accumulates various pieces of data and thus makes up a database, and an interface unit 13 that performs information exchange with the outside.

The CPU 11 includes a control unit 111 that executes a control program that is set in advance and thus performs a given operation, and an analysis unit 112 that performs appropriate analysis processing that is based on given data. Furthermore, the data accumulation unit 12 includes an operational information accumulation unit 121, a malfunction information accumulation unit 122, and a service information accumulation unit 123. Functions of these will be described below.

For the configuration that is responsible for the user interface, the interface unit 13 includes an operation unit 131 that receives the operation input from the user (operator), and a display unit 132 on which various pieces of information are displayed in order be reported to the user. The operation unit 131, for example, has an input device such as a keyboard or a mouse. The display unit 132, for example, has a display device such as a liquid crystal display. Furthermore, the interface unit 13 has a communication unit 133 for communicating with other apparatuses to perform exchange of data. The communication unit 133 has the network connection function for connection to the communication line 2.

In the information communication system 100 that is configured as described above, various pieces of information that vary according to the operation of each of printers 5 and 6 are transmitted to the server apparatus 1 through the communication line 2 from the printer 6 or from the computers 3 and 4. The server apparatus 1 saves the operational information on each of the printers 5 and 6 individually in the operational information accumulation unit 121. Accordingly, the operational situations of the printers 5 and 6 and history of the operational situations are accumulated in the server apparatus 1. The pieces of operational information that are obtained from the printers 5 and 6 and are accumulated in the server apparatus 1 are provided for the remote monitoring of the printers 5 and 6.

In addition, malfunction prediction or cause analysis can be performed on the printer by the analysis unit 112 analyzing pieces of operational information that are obtained from multiple printers and are accumulated. It is possible to use a result of analysis as information for new-product development. Specifically, when a malfunction occurs in the printer, pieces of information relating to a failure situation, which are received through the communication line 2, or from a serviceman or the like that performs maintenance work at a place where the printer is installed are accumulated and saved in the malfunction information accumulation unit 122. The analysis unit 112 analyzes correlations between the pieces of operational information that are accumulated in the operational information accumulation unit 121 and the pieces of malfunction information that are accumulated in the malfunction information accumulation unit 122, thereby obtaining a cause and effect relationship between the operational information and the malfunction.

When this is done, for example, if a malfunction occurs in each of the printers 5 and 6, it is for the service provider to find a type or cause of the malfunction, a countermeasure method, and the like from the pieces of operational information on the printer. Furthermore, it is possible to avoid an occurrence of the malfunction by predicting an occurrence of the malfunction from the history of the operational information on the printer connected to the communication line 2 or by taking some countermeasures at that time. In this manner, the server apparatus 1 can monitor each of the printers 5 and 6 based on the accumulated pieces of operational information.

In order to effectively perform the remote monitoring in this manner, there is a need to transmit as many pieces of operational information as possible from the printers 5 and 6. Furthermore, in order to improve the precision of the analysis that is based on the accumulated pieces of operational information, there is a need to collect as many pieces of information as possible from the printer. To be more precise, there is a need to provide as many pieces of information as possible from as many of the users as possible. However, with respect to data transmission from the printer, if the user does not know what type of information is transmitted and how that information is used, the reluctance of the user cannot be removed. Accordingly, if sufficient information is not collected, this is disadvantageous to both the user and the service provider.

Then, in the information communication system 100, the user him/herself can select pieces of information that are transmitted from the printers 5 and 6 to the server apparatus 1. That is, in addition to recognizing and understanding what type of information is transmitted, the user can determine whether or not the transmission of these pieces of information is allowed. However, simply by leaving the user to determine whether or not to transmit the operational information, there is no direct merit for the user. Then, if a determination criteria is not understood, a propriety determination cannot be made.

In the information communication system 100, this problem is solved as follows. In the information communication system 100, service information relating to maintenance of the printer, is transmitted from the server apparatus 1 to the printers 5 and 6 whenever necessary. Contents of the service information that is transmitted to the multiple printers 5 and 6 are not uniform, and the service information that is provided varies according to the operational information that is transmitted from the printers 5 and 6.

That is, when many pieces of operational information are provided from the printers 5 and 6, because the operational situation of the printer is recognized in detail at the server apparatus 1 side, it is possible to provide more detailed service information useful to the maintenance of the printer to the user. On the other hand, if a small amount of information is provided, because the operational situation of the printer is understood only in a limited manner, the service information also can only be be provided in a more limited manner.

The user himself/herself can determine whether the more detailed service information is received by approving the transmission of many pieces of operational information, or the limited service information is received by limiting a type of operational information that is transmitted. When this determination is made, if it is indicated to the user that the service information suitable for the operational information that is transmitted is received, the user can make an appropriate determination while ascertaining a balance between desired service information and the operational information that has to be provided because of the desired service information.

A specific configuration that realizes the function described above will be described below. Moreover, among various pieces of operational information, operational information that is permitted by the user to be transmitted to the server apparatus is called “notification information.”

The setting of the notification information by the user is caused to be received by the system by performing given setting input on either of the computer and the printer through a user interface function. That is, the user can perform the setting input on the printer 5 that is connected to the communication line 2 through the computer 3, using the user interface function of the computer 3. Utility software for operating the printer 5 is built into the computer 3, and the user can select the notification information from among the various pieces of operational information, using a graphical user interface (GUI) that is displayed on the display unit 332 of the computer 3 by running the software. The setting input from the user is received by the operation unit 331. This may be performed using the user interface function of the printer 5.

On the other hand, the user can perform the setting input associated with the notification information, on the printer 6 connected directly to the communication line 2, using the user interface function of the printer 5. In this case, the setting input is received by the operation unit 531. However, the user interface function of the computer 4, which is connected to the LAN 22 in the same manner as the printer 6, and into which the utility software controlling the printer 6 is built, may be used for the setting input.

With respect to the selection of the notification information, the user can arbitrarily select the notification information from among the various pieces of operational information, but the various pieces of operational information can be also ranked and selected according to the ranking. Moreover, a case will be described where the printer 5 is managed using the computer 3, but this is also true for a case of the network printer 6.

The reason for doing this is as follows. When the various pieces of operational information are viewed from a point of view of the service provider, included in these pieces of operational information are pieces of information from basic information necessary for providing a minimum monitoring service for remotely monitoring the printer 5 to detailed information necessary only for realizing a higher-precision monitoring function. However, although only the detailed information may be transmitted in a state where the basic information is missing, a purpose of the monitoring is not necessarily accomplished. Furthermore, when viewed from a point of view of the user, because the user does not know which operational information is important for the monitoring, the user cannot determine which operational information may be set to be the notification information. When judged from these facts, the arbitrary selection of the notification information by the user is not necessarily useful.

At this point, the various pieces of operational information are ranked in advance, and the user makes a selection according to the ranking. The ranking needs to be appropriately performed according to a level of importance to the service provider in the monitoring of the printer, and such that the ranking ends in such a manner that, from the perspective of the privacy protection that is a main concern for the user, the higher the level of privacy the information has, the less of the information is disclosed. It is possible to provide the preferable notification information to the service provider and to provide a maximum amount of information within a scope of the privacy to the user while maintaining the desired level of privacy protection for the user, by setting the notification information that is based on the ranking of the pieces of information that is performed in this manner.

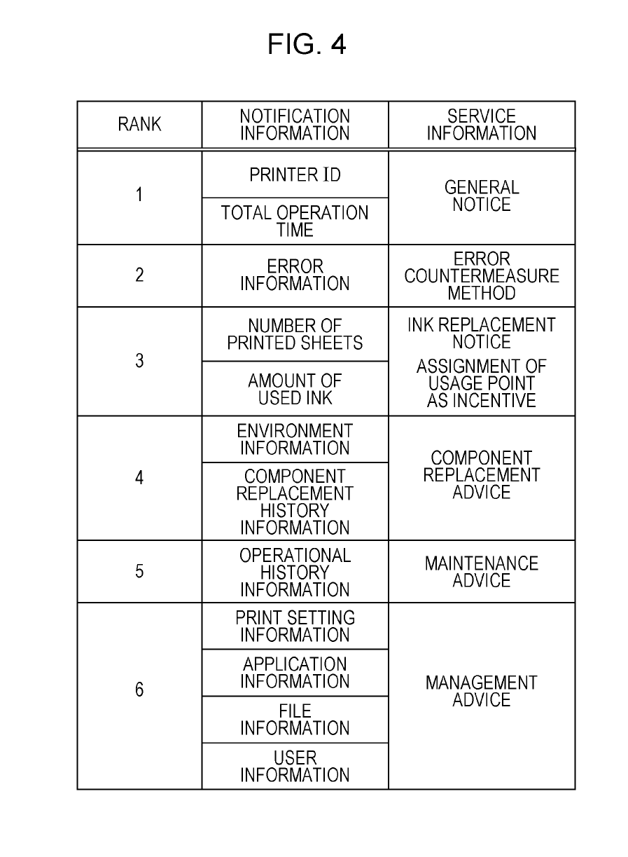

FIG. 4 is a diagram illustrating the ranking of the pieces of operational information. The basic idea for the ranking is that the higher the level of importance the information has in performing the monitoring of the printer, the higher the information is ranked and the lower the level of necessity of secrecy the information has from a point of view of the user, the higher the information is ranked. At the time, 12 types of operational information that are candidates for the notification information are ranked in six levels, but this illustrates one example. A type of the operational information to be used or a ranking order of the operational information, the number of ranking levels, and the like are not limited to this.

Among pieces of information that are transmitted as the notification information from the printer 5 to the server apparatus 1, pieces of information that have the highest ranking level are a printer ID that is an individual identification code of the printer and a total operation time of the printer. The inclusion of the printer ID in the data transmission from the printers 5 and 6 makes it possible for the server apparatus 1 to identify each printer. Furthermore, the total operation time of the printer is information for estimating the extent to which each unit of the apparatus may have deteriorated. These pieces of information are set to be pieces of notification information that have a ranking 1 indicating the highest level of importance.

In a case where the user allows information with the ranking 1 to be transmitted, to be more precise, selects the information as the notification information, service information corresponding to the ranking 1, among pieces of service information that are accumulated in the service information accumulation unit 123, is transmitted from the server apparatus 1 to the printer 5. In this case, because the detailed operational information on the printer 5 is not known, the service information that is provided is a general notice that does not depend on an object such as update information, or a precaution or the like against a deteriorating situation of the apparatus, which is read from the total operation time transmitted.

The notification information that is equivalent to a ranking 2 after the ranking 1, which indicates the second highest level of importance, is error information relating to an error that occurs in the printer 5. The error information is information that indicates a type of error when an error occurs such as a setting failure or a transporting failure of the recording medium or an operation failure of a print head. By transmitting error information to the server apparatus 1, the server apparatus 1 can recognize that an error has occurred in the printer 5, and for example, can guide a countermeasure method, as the service information, which is employed by the user in order to eliminate the error.

The pieces of notification information that are equivalent to a ranking 3 after the ranking 2, which indicate the third highest level of importance, are the number of pieces of the recording medium on which printing has been performed by the printer 5 and an amount of consumed ink. It is possible to determine a use mode of a transporting system of the print head or the recording medium to some extent from these pieces of information. In a case where the information with the ranking 3 is allowed to be transmitted, the server apparatus 1 can estimate the time at which ink will be in short supply from information on an amount of consumed ink, and can provide the estimated time as the service information to the user. Furthermore, for example, a special benefits, such as usage points as an incentive, which varies according to the amount of consumed ink or the number of printed sheets, may be assigned to the user.

The pieces of notification information that are equivalent to a ranking 4 after the ranking 3, which indicate the fourth highest level of importance, are environmental information indicating temperature within the printer 5 and component replacement history information indicating component replacement history to the current time. From these pieces of information, the server apparatus 1 can estimate a deterioration situation of each unit of the printer 5 with more precision, and can provide advice relating to the component replacement time and the like, as the service information, to the user.

Other pieces of operational history information may be set to be the notification information on the printer 5. These pieces of operational history information include, for example, history of maintenance such as an operation of cleaning the print head performed by the user. When information relating to details or frequency of the maintenance performed by the user is transmitted, the server apparatus 1 can provide advice relating to the maintenance time or a maintenance method, as the service information, to the user.

The pieces of notification information that are equivalent to a ranking 6 indicating the lowest ranking level are information relating to condition setting that is performed by the user on the printer 5, information relating to application software used in the printing, information relating to a file name corresponding to image data, information relating to attributes of the user himself/herself, and the like. Because these pieces of information have a comparatively high level of privacy, the reluctance of the user can be alleviated by lowering the ranking level. However, if these pieces of information are provided, it is possible for the server apparatus 1 to provide a user suitable situation-based advice relating to the operation of the printer 5, as the service information.

In this manner, the ranking is performed in such a manner that a high ranking is assigned to information that is thought to have a high level of importance in monitoring the printer 5 and to have a low level of necessity of secrecy for the user, and on the other hand, in such a manner that a low ranking is assigned to information necessary only for high-precision monitoring and that the higher the level of privacy the method has, the lower the method is ranked. Then, when the user sets information with a certain ranking as the notification information, all pieces of information that have a higher ranking than this information are set to be selected as the notification information. That is, when the user, for example, selects information with the ranking 3 as the notification information, information with the ranking 1 and information with the ranking 2 also need to be selected as the notification information. Information with the ranking 3 is prevented from being set to be the notification information without the information with the ranking 1 or with the ranking 2 being included in the notification information.

When this is done, the information important in monitoring the printer 5 is prevented from being omitted. Furthermore, a setting operation is made easy because the selection of the ranking according to which the transmission is approved without recognizing the level of importance for every piece of operational information is also possible for the user. In addition, when the user wants to receive a high-precision monitoring service, because information necessary for such a reason is selected without being omitted, a service with a desired level can be reliably received.

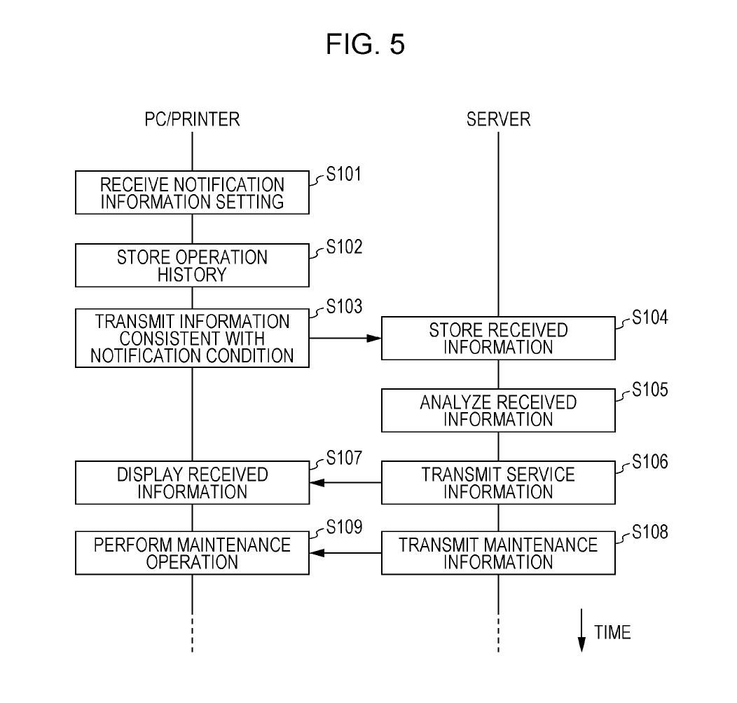

FIG. 5 is a diagram illustrating a communication protocol in the information communication system. First, the setting input of the notification information is received from the user through the user interface of the computer 3 (Step S101). At this time, a relationship between the notification information that is illustrated in FIG. 4 and the service information corresponding to the notification information is explicitly stated on the display unit 332 on which an image guiding the setting input is displayed. When this is done, the user can perform the setting while checking which service is received with which information being selected. Furthermore, because the operational information is assigned the ranking in advance and only the selection according to the ranking level is allowed, even in a case where multiple types of operational information are present, the selection can be made without hesitating.

A result of the selection as to which operational information is set to be the notification information, which is set by the user in this manner is stored for saving in the notification condition setting unit 312 of the CPU 31. Thereafter, when the printer 5 performs the print operation, the various types of operational information are transmitted from the printer 5 to the computer 3 each time or periodically, and are stored as operational history of the printer 5 for saving in the storage unit 32 (Step S102).

In a case where the received operational information is consistent with the notification information stored in the notification condition setting unit 312, the status notification unit 313 of the CPU 31 transmits the operational information to the server apparatus 1 over the communication unit 333 and the communication line 2 (Step S103). Therefore, the operational information that is transmitted to the server apparatus 1 is information that is selected by the user as the notification information.

For saving, the server apparatus 1 stores the received operational information in the operational information accumulation unit 121 (Step S104). Furthermore, the analysis unit 112 analyzes the operational information and determines a status of the printer 5 (Step S105), and selects the service information that is consistent with the status, from the service information accumulation unit 123 in which pieces of service information corresponding to various statuses are accumulated and are organized into a database, and then transmits the selected service information to the computer 3 (Step S106). Furthermore, when a malfunction of the printer 5 is determined from the operational information, a situation of the malfunction and the like are accumulated as the malfunction information in the malfunction information accumulation unit 122.

The computer 3 that receives the service information displays the service information on the display unit 332 for the report to the user (Step S107). A mode in which the service information is displayed on the display unit 532 that is installed in the printer 5 is possible. In this manner, the user can receive from the server apparatus 1 the service information that contains details appropriate for the provided operational information.

Furthermore, the server apparatus 1 may transmit maintenance information for performing any maintenance operation on the printer 5 when the transmission is determined to be necessary as a result of analyzing the operational information (Step S108). The printer 5 that receives this performs a predetermined maintenance operation that is determined in advance or is designated by the maintenance information (Step S109). As the maintenance operation, there are various types of operations for preventing a malfunction before the malfunction occurs and optimizing operation conditions for the printer 5, for example, an operation of cleaning the print head and a change in voltage that is applied to each unit of the apparatus. In this manner, information that is provided from the server apparatus 1 according to the provided operational information is not limited to a purpose of making a report to the user, and may relate to a main body of the printer 5.

The determination of the status of the printer 5 from the operational information and the reporting of the result of the determination to the user themselves are possible with only the computer 3 without using an external server apparatus 1. However, in order to receive a service that is based on pieces of information collected from the multiple printers 5, a mode is more desirable in which the user provides as many pieces of information on the printer 5 as possible to the server apparatus 1 and receives the service information in accordance with the provided information from the server apparatus 1.

Thereafter, Steps S102 to S109 are repeatedly performed according to the operation of the printer 5. Furthermore, the setting of the notification information in Step S101 may be performed again whenever necessary. Furthermore, the transmission of the notification information may be performed periodically, not each time the printer 5 operates.

As described above, according to the embodiment, the user can set which information, among various pieces of operational information that vary according to the operation of each of the printers 5 and 6, is transmitted as the notification information to the server apparatus 1. Then, among the various pieces of operational information, only information of which the transmission is approved by the user is transmitted to the server apparatus 1. Because the information for which secrecy is desired can be selected as being not transmitted, the reluctance of the user to transmit data can be alleviated.

Furthermore, the more pieces of information the user provides, the more pieces of service information the user receives. For this reason, because the user can perceive that the transmitted information is used in the monitoring of the printer, more users can be encouraged to provide more pieces of information. When this is done, the service provider that provides the maintenance service can provide a user who approves the provision of many pieces of information with the service appropriate for the information of which the transmission is approved. Furthermore, it is possible to analyze a cause of a malfunction or develop a new product with more efficiency by collecting more pieces of information from more of the users.

As described above, according to the embodiment, the computer 3 and the printer 5 function integrally as as an information processing apparatus according to the invention, and the printer 6 alone may function as the information processing apparatus according to the invention. Furthermore, the server apparatus 1 functions as a “monitoring apparatus” and an “information provision entity” according to the invention. Furthermore, the print engine 541 installed in the printers 5 and 6 functions as an “information acquirement unit” and an “image formation unit” according to the invention, and the sensor 542 and the counter 543 function as an “information acquirement unit” according to the invention.

Furthermore, in a mode in which, for the selection of the notification information, the user performs the setting input on the operation unit 331 of each of the computers 3 and 4, the operation unit 331 functions as a “receiving unit” according to the invention, and the communication unit 333 functions as a “communication unit” according to the invention. In a mode in which the setting input is performed on the operation unit 531 of each of the printers 5 and 6, the operation unit 531 functions as a “receiving unit” according to the invention, and the communication unit 533 functions as a “communication unit” according to the invention. Furthermore, in a mode in which the service information is displayed on the display unit 332 of each of the computers 3 and 4, the display unit 332 functions as a “reporting unit” according to the invention. Then, in a mode in which the service information is displayed on the display unit 532 of each of the computers 5 and 6, the display unit 532 functions as the “reporting unit” according to the invention.

Furthermore, in the data accumulation unit 12 installed in the server apparatus 1, the operational information accumulation unit 121 functions as a “storage unit” according to the invention. On the other hand, the CPU 11 functions as a “monitoring unit” according to the invention. Furthermore, the communication unit 133 functions as a “monitoring-side communication unit” according to the invention. Furthermore, the service provider that manages the server apparatus 1 is also equivalent to an “information provision entity” according to the invention, and the ranking assigned to the service information is equivalent to ranking order according to the invention. At this point, in terms of conception, the “information provision entity” includes both a service provider such as a person or a company that provides the service information, and a service provision apparatus such as a computer having such a service function.

In order to precisely perform the monitoring of the information processing apparatus, various pieces of operational information are necessary, and if information is insufficient, a monitoring function, of course, is limited. According to the mode described above, many pieces of information are provided and thus the detailed monitoring function is enjoyed, but the user himself/herself can select whether to receive only the monitoring function that is limited to a few pieces of information. Then, the user can receive the service appropriate for the provided information.

Furthermore, the service provider that provides the service for monitoring the information processing apparatus can individually provide a suitable monitoring function in accordance with a status of the apparatus to the user, by receiving more pieces of information. Then, feedback to an analysis of the cause of the malfunction or the development of a new product can be provided by being able to collect more pieces of information from the user.

In the system described above, multiple types of operational information are ranked based on a given criteria, and the communication unit is configured in such a manner that, among the multiple types of operational information, pieces of operational information from operational information with the highest ranking down to operational information with the ranking corresponding to a result of the setting unit are transmitted.

There are various types of operational information from operational information necessary for minimum management of the apparatus to operational information necessary only for high-precision management. For this reason, although the user can arbitrarily select operational information from among the various type of operational information, a combination of these pieces of operational information is not necessarily effective. Then, more efficient management is possible if pieces of operational information are ranked based on a certain criteria and the user makes a selection according to such a ranking order. Moreover, as a criteria for ranking, a level of importance, for example, is possible for the management described above, and a level of necessity of secrecy, for example, is possible from a point of view of the protection of the user.

Furthermore, the information processing apparatus is configured to include the reporting unit that associates a type of operational information that is transmitted by the communication unit and the service information that is received from the outside according to the operational information, with each other, and reports the resulting association to the user. With this configuration, as in the information communication system, because a relationship between the operational information that is transmitted from the information processing apparatus and the received service is made clear, a selection operation by the user can be efficiently supported.

Furthermore, the information processing unit may have the image formation unit that forms an image that is based on image data on a recording medium. This type of image formation unit is configured from many constituent components including movable components, consumables, and the like. Furthermore, a management method varies greatly from one user to another. For this reason, there are various malfunctions that can occur from a minor malfunction that an ordinary user can cope with to a malfunction that a full time operator has to cope with. Such an apparatus is an apparatus particularly suitable as a target for continuous remote monitoring. Thus, by applying the invention to an apparatus that has the image formation unit, a malfunction is prevented before the malfunction occurs, and even if a malfunction occurs, it is possible to receive information for taking prompt countermeasures from the outside.

Moreover, the invention is not limited to the embodiments described above, and various modifications other than those described above can be made within a range that does not depart from the nature and gist of the invention. For example, as described above, the type or ranking of operational information described above, the type of service information corresponding to the type or ranking of operational information, and the like are simple examples, and the invention is not limited to these.

Furthermore, for example, according to the embodiment described above, the service information in accordance with a result of analyzing the operational information on the printer 5, which is received by the server apparatus 1, is transmitted to the printer 5, but a mode of the provision of the service information is not limited to this. For example, the analysis of the operational information may be performed by an engineer. That is, the server apparatus 1 displays the received operational information on the display unit 132 for reporting to the engineer, and the engineer who views the displayed operational information may determine a status of the printer 5, thereby designating suitable service information through the operation unit 131.

For example, when an error occurs in the printer 5, if a cause of the error or a countermeasure method can be specified from the pieces of operational information and accumulated pieces of information on past cases, the server apparatus 1 can select suitable information from the pieces of service information that are organized into a database and can automatically transmit the selected suitable information to the printer 5. However, the engineer needs to individually cope with an error for which there is no precedent, and it is desirable to install a function for serving this purpose in the server apparatus. In the server apparatus 1 according to the invention, it is possible for the operation unit 131 and the display unit 132 to realize this function. Results of the analysis by the engineer are accumulated as new malfunction information in the malfunction information accumulation unit 122. When this is done, it is possible for the server apparatus 1 to automatically cope with the same type of error thereafter.

Furthermore, for example, according to the embodiment described above, when the operational information is supplied from the user, the service information appropriate for the operational information is provided from the service provider. However, the maintenance service that is provided by the service provider and is obtained is not limited to this. For example, even in a case of the maintenance service where, when the printer 5 malfunctions, the serviceman is dispatched to cope with the malfunction, if the status of the printer 5 is not understood, the countermeasure method is not determined until checking is actually performed. In contrast, if many pieces of operational information are transmitted in advance from the printer 5 and are accumulated in the server apparatus 1, a service can be provided that is desirable for the user in that a cause of the malfunction is determined and a replacement component is carried.

Furthermore, the information processing apparatus according to the embodiment described above includes the print engine 541 that is of an ink jet type, as the “image formation unit” according to the invention, but a printing type is not limited to being of the ink jet type and is arbitrary. In addition, the “information processing apparatus” according to the invention is not limited to one that has a print function in this manner. It is possible to build various electronic components connectable directly or indirectly to the communication line 2, as the “information processing apparatus” according to the invention, into the information communication system. Specifically, an electronic apparatus that includes movable components, components to which high voltage is applied, or the like are suitable for being built into the information communication system according to the invention.

The entire disclosure of Japanese Patent Application No. 2014-065428, filed Mar. 27, 2014 is expressly incorporated by reference herein.

What is claimed is:

1. An information communication system comprising:
an information processing apparatus; and
a monitoring apparatus that communicates with the information processing apparatus to monitor the information processing apparatus,
wherein the information processing apparatus includes
an information acquirement unit that acquires multiple types of operational information which vary according to operation of the information processing apparatus,
a receiving unit that receives a setting input for selecting operational information that is transmitted to the monitoring apparatus, from among the multiple types of operational information, and
a communication unit that transmits the operational information selected by the setting input to the receiving unit to the monitoring apparatus, and
wherein the monitoring apparatus includes
a storage unit in which the operational information transmitted from the information processing apparatus is stored, and
a monitoring unit that monitors an operational situation of the information processing apparatus based on the operational information stored in the storage unit.

2. The information communication system according to claim 1,
wherein the multiple types of operational information are ranked based on a given criteria, and
wherein, among the multiple types of operational information, the communication unit transmits pieces of operational information from operational information with the highest ranking down to operational information with a ranking corresponding to a result of the setting input.

3. The information communication system according to claim 1,
wherein the monitoring apparatus includes a monitoring-side communication unit that transmits information to the information processing apparatus, and
wherein among multiple types of service information relating to maintenance of the information processing apparatus, the monitoring unit transmits service information in accordance with a type of the operational information that is transmitted from the information processing apparatus, to the monitoring-side communication unit.

4. The information communication system according to claim 3,
wherein the information processing apparatus includes a reporting unit that reports the service information that is transmitted from the monitoring apparatus.

5. The information communication system according to claim 4,
wherein the reporting unit reports a type of the operational information that is transmitted by the communication unit and a type of service information that is received from the outside according to the operational information with the type of the operational information and the service information being associated with each other.

6. The information communication system according to of claim 1,
wherein the monitoring unit creates maintenance information necessary for maintenance work for the information processing apparatus based on the operational information stored in the storage unit.

7. The information communication system according to of claim 1,
wherein multiple information processing apparatuses communicate with the one monitoring apparatus over a communication line.

8. An information processing apparatus comprising:
an information processing unit;
an information acquirement unit that acquires multiple types of operational information that vary according to operation of the information processing unit;
a communication unit that communicates with an external apparatus; and
a receiving unit that receives a setting input for selecting operational information for the communication unit to transmit from among the multiple types of operational information,
wherein the communication unit transmits the operational information selected by the setting input to the receiving unit to the external apparatus.

9. The information processing apparatus according to claim 8, further comprising:
a reporting unit that reports a type of the operational information that is transmitted by the communication unit and service information that is received from the outside according to the operational information with the type of the operational information and the service information being associated with each other.

10. The information processing apparatus according to claim 8,
wherein the information processing unit has an image formation unit that forms an image that is based on image data, on a recording medium.

11. The information processing apparatus according to claim 10,
wherein the operational information includes information relating to consumables that are consumed according to operation of the image formation unit.

12. An information provision method of providing service information relating to maintenance of an information processing apparatus that has a communication function, from an information provision entity to a user, the method comprising:
causing the user to select operational information to be transmitted to the information provision entity, from among multiple types of operational information that vary according to operation of the information processing apparatus;
transmitting the operational information selected by the user from the information processing apparatus to the information provision entity; and
providing service information in accordance with the transmitted operational information among multiple types of service information from the information provision entity to the user.

13. The information provision method according to claim 12,
wherein the multiple types of operational information are ranked based on a given criteria, and
wherein a combination of the pieces of operational information selectable by the user is limited based on a ranking order.

14. The information provision method according to claim 12,
wherein the more pieces of operational information the information processing apparatus transmits, the greater the number of types of service information that is provided.
